(19) United States
(12) Patent Application Publication
(10) Pub. No.: US 2026/0212026 A1
(43) Pub. Date: Jul. 23, 2026

(54) SYSTEM AND METHODS FOR AUTOMATED IDENTIFICATION AND REPAIR OF SOURCE CODEVULNERABILITIES

(71) Applicant: Board of Regents, The University of Texas System, Austin, TX (US)

(72) Inventors: Nafis Islam, San Antonio, TX (US); Peyman Najafirad, San Antonio, TX (US)

(21) Appl. No.: 19/457,083

(22) Filed: Jan. 22, 2026

Related U.S. Application Data
(60) Provisional application No. 63/748,426, filed on Jan. 22, 2025.

(51) Int. Cl. G06F 21/57

(52) U.S. Cl. CPC G06F 21/577; G06F 2221/033

(57) ABSTRACT

This patent describes a new technology designed for use in autonomous systems, like self-driving cars, automated manufacturing robots, smart contracts. The technology automatically finds and fixes problems in the software code of these systems. It uses advanced learning methods to understand different types of code and improve its ability to fix problems. The system not only repairs the code by itself but also explains the repairs in a way that people can understand.

### PRIORITY

This application claims the benefit of priority under 35 U.S.C. § 119 (e) to U.S. Provisional Patent Application No. 63/748,426, filed Jan. 22, 2025, the entire contents of which are hereby incorporated by reference.

### FIELD OF INNOVATION

This relates to software security, and in particular, embodiments of the present disclosure relate to the identification and repair of software vulnerabilities.

### BACKGROUND

Recent advancements in neural language modeling and state-of-the-art Large Language Model (LLM)-based auto-completion tools, such as GitHub Copilot, TabNine, IntelliCode, and ChatGPT, have significantly improved software architecture and development, making it a crucial feature in modern code editors and Integrated Development Environments (IDEs). However, these advancements have also raised valid questions about their training datasets and processes, generated code outputs, and most importantly, code semantic and security resilience. Generating a repair for programs is a challenging task because, to repair a program, we initially need the vulnerable line and, furthermore, must generate an appropriate compilable line to fix the vulnerability.

### BRIEF DESCRIPTION OF THE DRAWINGS

Embodiments will be described, by way of example only, with reference to the attached figures, wherein in the figures:

FIG. 1 illustrates a high-level topology of identifying, repairing, and providing proper vulnerability description message. The proposed system utilizes a Large Language Model (LLM) with Reinforcement Learning method for training. The training process is further optimized with the use of the combination of syntactic and semantic loss.

FIG. 2 shows four examples demonstrating the four use cases of our model.

FIG. 3 shows the instruction data creation by utilizing the knowledge from software security experts.

FIG. 4 shows how the instruction and the code are combined and put thorough the model to generate the outcomes.

FIG. 5 shows how the semantic and syntactic loss function were used during the training process with reinforcement learning.

FIG. 6 shows how reinforcement learning was further used for code specific description generation process.

### SUMMARY OF INVENTION

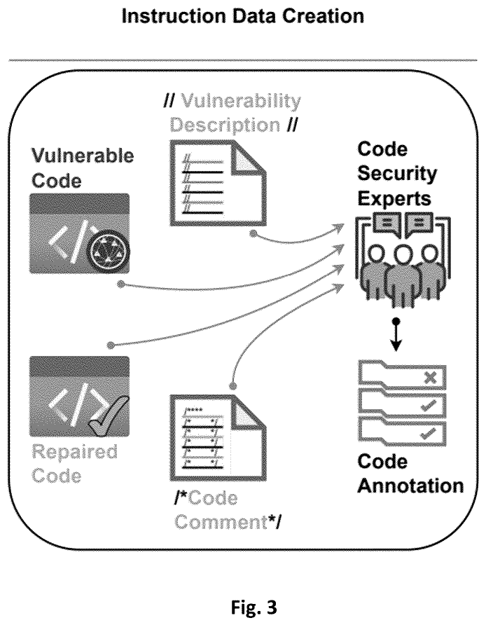

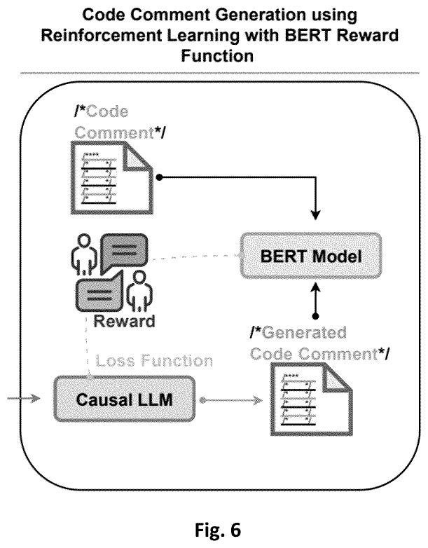

This work introduces a code vulnerability repair system SecRepair, powered by LLM, and incorporates reinforcement learning with a unique semantic reward technique. The proposed system is designed to help developers generate fixed code while comprehensively describing the vulnerability with a code comment. FIGS. 3-6 illustrate the architecture of our proposed work. Specifically, we divide the task of code vulnerability repair into two main stages: i) code repair and vulnerability description generation; and ii) code comment generation.

Code Vulnerability Repair: To achieve code vulnerability repair and description, a prior fundamental step needs to be completed, namely, vulnerability identification and localization (i.e., pinpointing the vulnerable line in the code). This fundamental step, along with the proposed pipeline, heavily relies on a carefully created instruction dataset consisting of vulnerable code coupled with its repaired code.

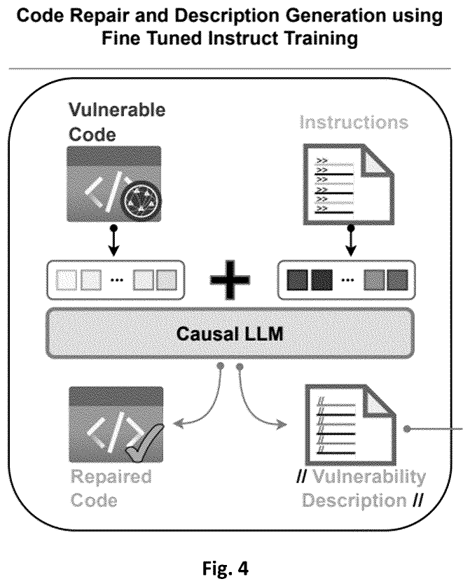

At FIG. 4, there are two data inputs: a vulnerable code and an instruction to train SecRepair. The model learns the representation of the code through the training process, enabling vulnerability localization and repair. Once the model has been adequately trained on instruction fine-tuning for code vulnerability detection, it inherently achieves representation for localization. Our dataset provides repaired versions for each vulnerable code, facilitating our model's understanding of the difference between vulnerable and non-vulnerable code pairs. This method imparts an internal representation of localized vulnerable lines during vulnerability identification training. Additionally, the model is optimized for vulnerable code detection and repair by using Cross-Entropy Loss as the optimization criterion, and beam search is utilized to select multiple vulnerability repair candidates based on conditional probability for our input.

One of the major challenges with code vulnerability repair is that the code sample can be composed of a high number of tokens. Moreover, code writing, execution, and repair is a sequential task that requires a sequential understanding of the code tokens. However, regular encoder-decoder-based LLM architecture shows a bidirectional property where they read tokens from forward and backward. Such a bidirectional architecture causes unnecessary computation that is not needed for code vulnerability repair. Therefore, we introduce a simple but effective modification to encoder-decoder architecture for longer code sequences by dropping the encoder module. Then we combine the input and output sequences into a single sequence and train as a standard language model. In addition to faster inference time, we also decrease the memory footprint by almost half. Thus, we convert the entire input-output sequence into a sequence of tokens, t₁, t₂, . . . tₚ∈T and y₁, y₂, . . . y_{q}∈Y, into a single sequence w₁, w₂, . . . w_{p+q}=(t₁, . . . , tₚ, y₁, . . . , y_{q}, where \$ is a special token separating inputs and outputs. Here p is the number of input tokens, and q is the number of output tokens. We train the model auto-regressively to predict the next word given the previous ones using the following equation:

$$p ( {w}_{1} , {w}_{2} , ... {w}_{p + q} ) = {\prod }_{j = 1}^{p + q} ( {w}_{i} \vert {w}_{1} , ... , {w}_{j - 1} )$$

Given the causal decoder architecture of SecRepair, our model is forced to predict the next code token, and the model cannot overlook future tokens by looking at the next token during output generation. The model is provided with the input sequence $t_i\in T$ during inference, which in turn auto-regressively generates the output, yᵢ

Policy Optimization: The reinforcement learning objective is to find the optimal policy by maximizing the cumulative syntactic and semantic reward by adding security measures while keeping code functionality checked. To meet this requirement, we introduce a syntactic code evaluation technique, CodeBLEU, as a reward value to check the syntactic similarity between the repaired lines generated by the model and the ground truth repair. Here, the repaired line refers to the new line the model is expected to generate to add security measures to the code. Furthermore, to ensure the functional correctness in the generated outcome, we utilize BERTScore as a semantic reward value that quantifies the semantic similarity or functionality between the entire input vulnerable code and the generated repaired code. If the original vulnerable code is $fᵥᵤₗ$, the repaired code generated by the model is

$$\$ \text{?} - \$ ,$$

and the ground truth repaired code is fᵣₑₚ. As such, we calculate the policy optimization r, using the following equation:

$$L ( r\_θ ) = log ( σ ( r\_θ ( f\_ \{ vul \} , f\_ \{ rep \} ) - r\_θ ( f\_ \{ vul \} , \hat{} \{ f\_ \{ rep \} \} ) )$$

Reward: We calculate the reward by combining the CodeBLEU score and BERTScore. CodeBLEU is the weighted combination BLEU score, BLEU_{weight} is the weighted n-gram match, obtained by comparing the generated code and the ground truth repaired code tokens, Matchₐₛₜ is the AST match, exploring the syntactic information of code, and Match_{df} is the dataflow match, considering the similarity between ground truth and generate code.

$${R}_{CodeB} = α \cdot B + β \cdot {B}_{weight} + \backslash δ \cdot {Match}_{ast} + γ \cdot {Match}_{df}$$

Here, B in the equation stands for BLEU.

Furthermore, we use BERTScore for semantic comparison using cosine similarity score. A BERT vector represents tokens that permit the generation of a soft similarity measure instead of exact matching. The cosine similarity of a reference token from ground truth repair

$$\$ {t}_{r}^{i}$$

and a candidate token

$$\text{?} ,$$

we calculate the cosine similarity as

$${( {t}_{r}^{i} )}^{T} \text{?} .$$

Therefore, the F1 measurement of the BERTScore stands as follows.

$${R}_{BERT} = \frac{1}{\vert {t}_{r}^{i} \vert} {\sum }_{{t}_{r}^{i} ∈ T} max {( {t}_{r}^{i} )}^{T} \text{?}$$

where R_{BERT} is our expected BERTScore. We combine previous two equations to get the final reward value. The final reward is calculated as follows:

$$R = {R}_{CodeB} + {R}_{BERT}$$

Here, R is the final calculated reward value.

Reinforcement Learning for Code Comment: Then, the pre-trained SecRepair is cloned and employed to generate a developer-friendly description. After the successful generation of developer-friendly descriptions, we generate code comments. Code comments present a shorter version of a developer-friendly description while maintaining the same semantic meaning. It is a concise version of the description which the developers place at the code repair location as a commit message. Therefore, we fine-tune our model for a text-to-text task where the generated text is significantly shorter but still conveys the semantic meaning of the original description. To achieve the latter, we propose a reinforcement learning technique with a semantically aware reward function with the Proximal Policy Optimization (PPO) algorithm outlined by Schulman et al. to fine-tune the learning environment. We denote the input as the developer-friendly description, $D$, and the commit comment as D_{c}, and the output sequence is

$${w}_{1}^{c} , {w}_{2}^{c} , … {w}_{k}^{c} ,$$

where k is the total number of output tokens which is significantly shorter than the length of D. We define the token-wise generative summarization process as a deterministic Contextual Markov Decision Process with observable context from previous tokens. The sequence generated is the state at the kth token generation. A policy π(⋅|w^{c}:k−1,t) is the probability distribution over all input tokens from description D, conditioned on the context and state.

Policy Optimization: The reinforcement learning objective is to find the optimal policy that maximizes the cumulative reward signal by shortening the description and by keeping the semantic meaning. To meet this requirement, we introduce a BERTScore with reinforcement learning as a metric that quantifies the semantic similarity between two texts and generates a reward score. If the original description is D, commit message description generated by the model is $\hat{D_c}$ and the ground truth commit comment is D_{c}. As such, we calculate the policy optimization r, using the following equation:

$$L ( r\_θ ) = log ( σ ( r\_θ ( D , D\_c ) - r\_θ ( D , {}^{{\hat{}}^{}} \{ D\_c \} ) )$$

where r_{θ}(D,D_{c}) and r_{θ}(D, [symbol] ) is the scalar output of the reward model for the description D. Here σ is the activation function, and $\theta$ is the learnable parameter.

Reward: Reward is calculated by introducing BERTScore, a semantic comparison using the cosine similarity score. A BERT vector representation of tokens permits the generation of a soft measure of similarity rather than exact matching. The cosine similarity of a reference token

$${d}_{C}^{i}$$

and a candidate token

$$\text{?} ,$$

we calculate the cosine similarity as

$${( {d}_{C}^{i} )}^{T} \text{?} .$$

Therefore the F1 measurement of the BERTScore stands as follows;

$${R}_{B E R T} = \frac{1}{\vert {d}_{C}^{i} \vert} {\sum }_{{d}_{C}^{i} ∈ d} {max ( {d}_{C}^{i} )}^{T} \text{?}$$

where R_{BERT} is our expected BERTScore.

Instruction Dataset: This work is the first to introduce InstructVul, a new instruction-based dataset for vulnerability identification and repair system with a description and code comment generation. InstructVul is comprised of four components based on four tasks; they are 1) Vulnerability Identification, 2) Vulnerability Repair, 3) Vulnerability Description, and 4) Code Comment Generation. The following subsections define our dataset formally, followed by an in-depth description of its creation.

To create an instruction-based dataset for identification we initially leverage the vulnerable and non-vulnerable function pairs from VulDeelocator, which consists of multiple C/C++ files, each containing a vulnerable code and corresponding repaired code. Building upon this foundation, we extend the dataset by incorporating instructions with descriptions and code comments.

Input Generation: Our input consists of the instruction we provide in natural language, and the context input is a code. We combine these two to generate the final input. Based on the four tasks we perform, our security experts created 20 seed questions for each task. In order to provide context to the instruction, we use the vulnerable code as the contextual input. Context input act as a supplement to the instruction.

Output Generation: Based on the task provided by our instruction, we provide four types of output. Firstly if the instruction asks to identify the vulnerable code, the output is yes/no, indicating the existence of a vulnerability in the code. Secondly, if the instruction asks about generating the fixed code, the output is the repaired code we obtained from VulDeelocator. If the instruction is about describing the vulnerability in code, the output will be a description of why the code is vulnerable with a possible hint to fix it. Finally, the if the instruction asks to generate a code comment, the output will be a shortened and concise version of the original description.

Description Generation: We consider code description as a combination of describing the code objective and explaining the vulnerability of the code with a possible hint to fix the vulnerability. We generate the code description using the code generative model CodeAlpaca. This model was initially fine-tuned to generate texts based on instruction. Therefore we use this model to generate the objective of vulnerable code as a part of our description. We also extract the generic description of the vulnerable code for CWE with a hint to solve the vulnerability. We combine these two together and create a comprehensive description for each vulnerable code.

Code Comment Generation: Furthermore, we added code comments for each vulnerable code. A code comment is a shortened and concise version of the vulnerable code that a developer uses during a code commit. Our security experts and developers handcrafted 1000 code commits which took approximately 80 human hours. They used the descriptions as a suggestion to generate the code comments. In order to keep the comments concise, all the comments are kept between one to three lines.

After creating all the components, we combine these with specific instructions based on their task. Therefore in total, we have 18086 entities in our dataset.

Code Quality: Extracting vulnerable and repaired functions from a single file in the VulDeelocator dataset presented challenges due to inconsistent formatting. The placement of vulnerable code and their repaired code were always not consistent. Furthermore, approximately in 5\% of cases, vulnerable code does not have a fix and was not added as a part of our dataset. We developed a robust regular expression to identify each function's start accurately and used JOERN to extract individual vulnerable and non-vulnerable code. Subsequently, we verified the correctness of the repaired code manually by having security experts randomly examine 200 entities of our dataset with their corresponding repairs, descriptions, and code comment.

### Definitions

The following terms, as used in this disclosure and the appended claims, shall have the meanings set forth below unless the context clearly requires otherwise. These definitions are provided to clarify the scope of the invention and are not intended to limit terms to their ordinary meaning where a different interpretation is expressly supported herein.

Code data: Source code or portions thereof extracted from one or more databases or repositories, including but not limited to function-level code snippets from programming languages such as C or C++. Code data may include vulnerable code, non-vulnerable code, or repaired code.

Instruction database: A collection of training or input data formed by combining code data with natural language user instructions, wherein the instructions prompt tasks such as vulnerability identification, repair, description generation, or code comment generation. The instruction database may include paired vulnerable and repaired code examples with associated annotations.

Tokens: Discrete units into which code data or text is divided for processing by a model, generated using a tokenizer pre-trained on one or more programming languages.

Serialized token embedding: A numerical vector representation assigned to each token or feature of the tokenized code data, wherein tokens are mapped into a continuous embedded space to capture semantic and syntactic relationships for input to a machine learning model.

Large Language Model (LLM): A neural network-based model trained on large corpora of text and/or code, capable of processing serialized token embeddings to perform generation, classification, or analysis tasks. In embodiments, the LLM employs a causal decoder architecture.

Reinforcement Learning Model: A machine learning framework that optimizes a policy through interaction with an environment by maximizing cumulative rewards, used herein in collaboration with the LLM to refine code vulnerability analysis, repair, and description generation. In embodiments, the Reinforcement Learning Model employs Proximal Policy Optimization (PPO).

Vulnerabilities: Security weaknesses or flaws in code data that may allow unintended behavior, exploitation, or compromise, including but not limited to those identifiable in source code such as buffer overflows, injection vulnerabilities, or improper resource handling.

Analyzing and repairing vulnerabilities: The process of (i) identifying one or more vulnerable lines or portions within code data using learned representations from an instruction dataset, and (ii) generating one or more corrected or secured versions of the code data that mitigate the identified vulnerabilities while preserving intended functionality.

Dynamic and static description: Textual explanations of code data vulnerabilities and repairs, wherein static descriptions refer to fixed attributes (e.g., based on Common Weakness Enumeration (CWE) identifiers or general vulnerability characteristics), and dynamic descriptions refer to context-specific explanations tailored to the particular code sample, including developer-friendly narratives or commit messages.

Syntactic reward: A numerical value computed using a CodeBLEU score to measure syntactic similarity between generated repaired code and a reference (ground truth) repaired code, incorporating weighted components such as n-gram match, abstract syntax tree (AST) match, and dataflow match.

Semantic reward: A numerical value computed using a BERTScore to measure semantic or functional similarity between original code data and generated repaired code, based on cosine similarity of contextual token embeddings (e.g., from a BERT-derived model) and an F1 measure.

Code comment: A concise textual annotation (typically one to three lines) embedded in or associated with repaired code, summarizing a vulnerability description in a format suitable for use as a commit message or inline documentation while preserving core semantic meaning.

### DETAILED DESCRIPTION OF FIGURES

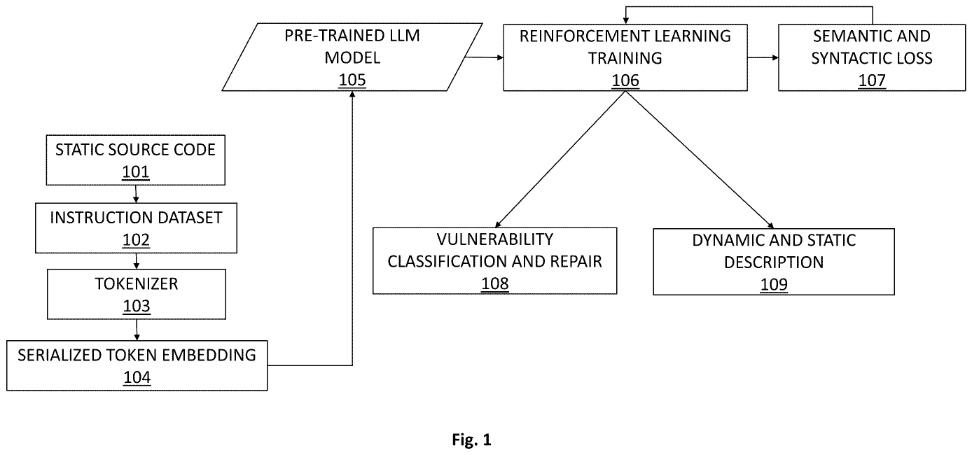

FIG. 1 illustrates a high-level topology of a vulnerability analysis system. In FIG. 1, blocks 101 through 109 correspond to the overall pipeline of an exemplary reinforcement learning based framework for static source code vulnerability analysis. Block 101 represents the extracted source code from various open-source repositories from GitHub. In one embodiment, a repository scanner employs the open-source code analysis platform Joern for code extraction at a function level from IoT operating systems' source code. The primary functionality of Joern includes scanning C/C++ files to generate a Code Property Graph (CPG). This CPG is a graphical representation capturing the fundamental aspects of the source code. The CPG is stored within an in-memory graph database, OverflowDB. The CPG facilitates the execution of intricate search operations within the source code via Scala-based queries. This capability enables the retrieval of significant data, such as extracting all functions from the repository and pertinent metadata. These include the total count of scanned files, the number of C/C++ codes, function definitions, internal and external function calls, and commits, providing us with a comprehensive code overview.

Block 102 shows an instruction dataset. The instruction dataset provides interactive property, which helps the developer ask code security related questions and instruction to the system. Block 102 encompasses the formation of instruction dataset by combining code with instruction.

In block 103, a tokenizer is utilized. Tokenization plays a crucial role in analyzing code in vulnerability detection. By breaking code into tokens, security tools can identify patterns and anomalies that might indicate potential vulnerabilities. In the present approach, the input consists of an entire function, which may be vulnerable or non-vulnerable. In one embodiment, a CodeT5 tokenizer is initially employed. The CodeT5 tokenizer is pretrained in programming languages like C/C++, to extract the tokens T from a given function pᵢ.

In block 104, the extracted tokens are passed ROBERTa to generate embeddings. Embedding is a powerful technique used in machine learning to represent complex data, like text or code, in a way that computers can understand and process effectively. It involves transforming the data into numerical vectors that capture the meaning and relationships within the data. Block 104 represents the generation of serialized token embedding.

Block 105 represents a pretrained Large Language Model (LLM) to process the serialized token embedding. Block 106 represents the reinforcement learning training for repairing and describing code vulnerabilities. The reinforcement learning objective is to find the optimal policy that maximizes rewards over time. The reinforcement learning training evaluates both syntax and semantics to assign rewards. The reinforcement learning training ensures that the generated or improved code includes security considerations while keeping code functionality checked.

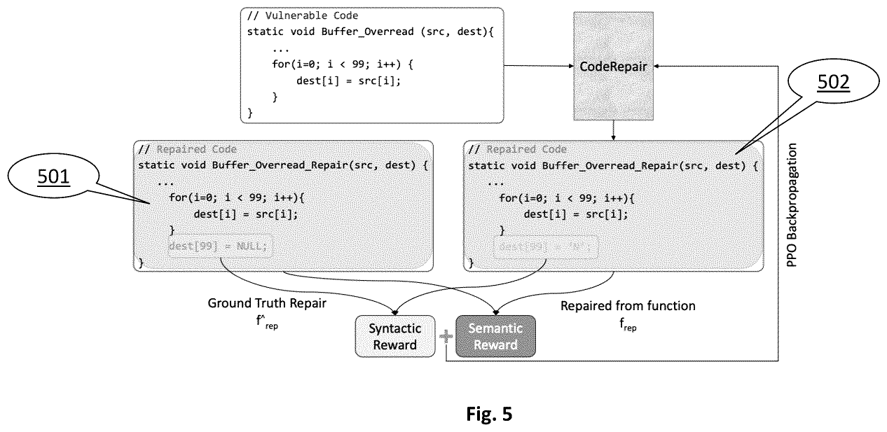

Block 107 represents the syntactic and semantic loss functions. FIG. 5 shows how the semantic and syntactic loss function were used during the training process with reinforcement learning. A syntactic code evaluation technique, CodeBLEU, is employed as a reward value to check the syntactic similarity between the repaired lines generated by the model and the ground truth repair. Here, the repaired line refers to the new line the model is expected to generate to add security measures to the code. Furthermore, to ensure the functional correctness in the generated outcome, we utilize BERTScore as a semantic reward value that quantifies the semantic similarity or functionality between the entire input vulnerable code and the generated repaired code. If the original vulnerable code is $fᵥᵤₗ$, the repaired code generated by the model is $ [symbol] $, and the ground truth repaired code is fᵣₑₚ. As such, we calculate the policy optimization r, using the following equation:

$$L ( r\_θ ) = log ( σ ( r\_θ ( f\_ \{ v u l \} , f\_ \{ r e p \} ) - r\_θ ( f\_ \{ vul \} , {}^{\hat{}} \{ f\_ \{ rep \} \} ) )$$

We calculate the reward by combining the CodeBLEU score and BERTScore. CodeBLEU is the weighted combination BLEU score, BLEU_{weight} is the weighted n-gram match, obtained by comparing the generated code and the ground truth repaired code tokens, Matchₐₛₜ is the AST match, exploring the syntactic information of code, and Match_{df} is the dataflow match, considering the similarity between ground truth and generate code.

$${R}_{C o d e B} = α \cdot B + β \cdot {B}_{w e ight} + ∖ δ \cdot {Match}_{ast} + γ \cdot {Match}_{df}$$

Here, B in the equation stands for BLEU.

Furthermore, we use BERTScore for semantic comparison using cosine similarity score. A BERT vector represents tokens that permit the generation of a soft similarity measure instead of exact matching. The cosine similarity of a reference token from ground truth repair

$$\$ {t}_{r}^{i}$$

and a candidate token

$$\text{?} ,$$

we calculate the cosine similarity as

$${( {t}_{r}^{i} )}^{T} \text{?} .$$

Therefore, the F1 measurement of the BERTScore stands as follows.

$${R}_{B E R T} = \frac{1}{\vert {t}_{r}^{i} \vert} {\sum }_{{t}_{r}^{i} ∈ T} {max ( {t}_{r}^{i} )}^{T} \text{?}$$

where R_{BERT} is our expected BERTScore. We combine previous two equations to get the final reward value. The final reward is calculated as follows:

$$R = {R}_{C o d e B} + {R}_{B E R T}$$

Here, R is the final calculated reward value.

Block 108 represents the vulnerability identification and repair. To achieve code vulnerability classification and repair, a prior fundamental step needs to be completed, namely, vulnerability identification and localization (i.e., pinpointing the vulnerable line in the code). This fundamental step, along with the proposed pipeline, heavily relies on a carefully created instruction dataset consisting of vulnerable code coupled with its repaired code.

As shown in FIG. 4, there are two data inputs: a vulnerable code and an instruction to train SecRepair. The model learns the representation of the code through the training process, enabling vulnerability localization and repair. Once the model has been adequately trained on instruction fine-tuning for code vulnerability detection, it inherently achieves representation for localization. Our dataset provides repaired versions for each vulnerable code, facilitating our model's understanding of the difference between vulnerable and non-vulnerable code pairs. This method imparts an internal representation of localized vulnerable lines during vulnerability identification training. Additionally, the model is optimized for vulnerable code detection and repair by using Cross-Entropy Loss as the optimization criterion, and beam search is utilized to select multiple vulnerability repair candidates based on conditional probability for our input.

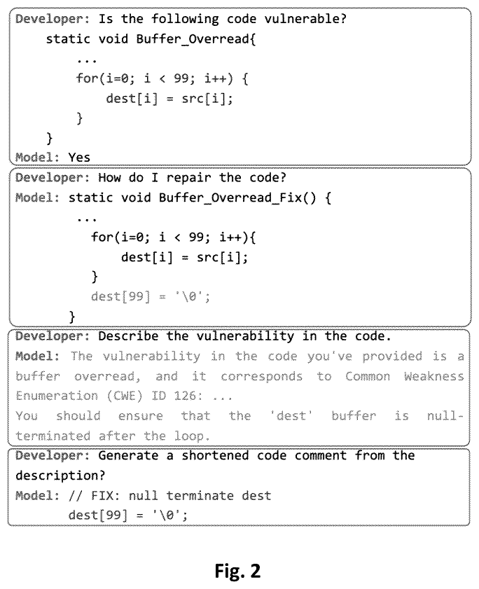

Block 109 depicts the dynamic and static description. In FIG. 2, the first case demonstrates vulnerability identification; the second one denotes vulnerability repair quality; the third one shows the vulnerability description based on the CWE number; and the fourth one shows the code specific description of the vulnerability.

FIG. 5 introduces the combination of syntactic and semantic reward values to enhance the capability of our model to generate secure and functional code. This helps in enforcing the model to generate code which is functionally correct and at the same time maintains all the proper security measures.

What is claimed is:

1. A method for identifying code vulnerabilities on a computing device, comprising:
extracting code data from a database;
forming an instruction database by combining the code data with user instructions;
converting the code data into tokens for processing;
generating a serialized token embedding, assigning each feature to an embedded space;
feeding the serialized token embedding into a large language model (LLM), wherein the LLM is configured to collaborate with a Reinforcement Learning Model for training;
analyzing and repairing vulnerabilities of the code data; and
generating a dynamic and static description of the code data.

2. The method of claim 1, wherein the LLM comprises a causal decoder architecture modified by removing an encoder module to process longer code sequences, combining input and output sequences into a single sequence separated by a special token, and training auto-regressively to predict next tokens based on previous ones.

3. The method of claim 1, wherein analyzing and repairing vulnerabilities comprises:
identifying a vulnerable line in the code data using representations learned from an instruction dataset comprising vulnerable and repaired code pairs; and
generating multiple repair candidates using beam search based on conditional probabilities.

4. The method of claim 1 further comprising:
evaluating semantic and syntactic similarity or functionality between the code data originally extracted from the database and the code repaired by the method; and
training the Reinforcement Learning Model with semantic and syntactic similarity or functionality results.

5. The method of claim 4, wherein evaluating semantic and syntactic similarity comprises:
calculating a syntactic reward using a CodeBLEU score, which includes a weighted n-gram match, abstract syntax tree (AST) match, and dataflow match between the repaired code and a ground truth repaired code; and
calculating a semantic reward using a BERTScore based on cosine similarity of token embeddings between the original code data and the repaired code.

6. The method of claim 5, further comprising combining the syntactic reward and semantic reward into a final reward value for policy optimization in the Reinforcement Learning Model, wherein the final reward value is calculated as a function of the CodeBLEU score and BERTScore F1 measure.

7. The method of claim 1, wherein forming the instruction database comprises:
leveraging vulnerable and non-vulnerable function pairs from a source dataset;
generating instructions based on seed questions created by security experts; and
incorporating contextual inputs from vulnerable code, along with outputs including vulnerability identification, repaired code, descriptions, and code comments.

8. The method of claim 1, further comprising generating a code comment as a concise version of a vulnerability description using a cloned pre-trained LLM fine-tuned with Proximal Policy Optimization (PPO) and a semantically aware reward function based on BERTScore to maintain semantic meaning while shortening the text.

9. A system for detecting and repairing code vulnerability attacks on a computing device, comprising:
a processor and a non-transitory computer-readable storage medium storing instructions that, when executed by the processor, cause the processor to perform a method comprising:
extracting code data from a database;
forming an instruction database by combining the code data with user instructions;
converting the code data into tokens for processing;
generating a serialized token embedding, assigning each feature to an embedded space;
feeding the serialized token embedding into a large language model (LLM), wherein the LLM is configured to collaborate with a Reinforcement Learning Model for training;
analyzing and repairing vulnerabilities of the code data; and
generating a dynamic and static description of the code data.

10. The system of claim 9, wherein extracting code data comprises using a code analysis platform to generate a Code Property Graph (CPG) from C/C++ source code in open-source repositories, storing the CPG in an in-memory graph database, and executing queries to retrieve function-level data and metadata.

11. A non-transitory computer-readable storage medium storing instructions that, when executed by a processor, cause the processor to:
receive source code from a repository;
tokenize the source code using a tokenizer pre-trained on programming languages;
generate embeddings from the tokens;
process the embeddings through an LLM integrated with reinforcement learning (RL), wherein the RL uses a combined syntactic and semantic reward to optimize vulnerability repair while preserving code functionality; and
output repaired code with an embedded code comment describing the vulnerability and repair.
